(19) United States
(12) Patent Application Publication
(10) Pub. No.: US 2021/0096737 A1
(43) Pub. Date: Apr. 1, 2021

(54) USE OF HOVER HEIGHT FOR CONTROLLING DEVICE

(71) Applicant: Lenovo (Singapore) Pte. Ltd., Singapore (SG)

(72) Inventors: Arnold S. Weksler, Raleigh, NC (US); Mark Patrick Delaney, Raleigh, NC (US); Russell Speight VanBlon, Raleigh, NC (US); Nathan J. Peterson, Oxford, NC (US); John Carl Mese, Cary, NC (US)

(21) Appl. No.: 16/588,565

(22) Filed: Sep. 30, 2019

(51) Int. Cl. G06F 3/0488; G06K 9/00; G06F 3/0484; G06F 3/041

(52) U.S. Cl. CPC G06F 3/04883; G06K 9/00355; G06F 2203/04108; G06F 3/0416; G06F 3/04847

(57) ABSTRACT

In one aspect, a device may include at least one processor, a display accessible to the at least one processor, and storage accessible to the at least one processor. The storage may include instructions executable by the at least one processor to identify, in a first instance, a first height of a hover of a portion of a user's body over the display. The instructions may also be executable to correlate the first height to a first user input parameter and to execute at least a first operation at the device in conformance with the first user input parameter.

### FIELD

The present application relates to technically inventive, non-routine solutions that are necessarily rooted in computer technology and that produce concrete technical improvements.

### BACKGROUND

As recognized herein, providing input to a smart phone or other device by touching its touch-enabled display (or by using other traditional input methods) limits the user's potential interactions with the device. As such, there are currently no adequate solutions to the foregoing computer-related, technological problem.

### SUMMARY

Accordingly, in one aspect a device includes at least one processor, a display accessible to the at least one processor, and storage accessible to the at least one processor. The storage includes instructions executable by the at least one processor to identify, in a first instance, a first height of a hover of a portion of a user's body over the display. The instructions are also executable to correlate the first height to a first user input parameter and to execute at least a first operation at the device in conformance with the first user input parameter.

In some examples, the first user input parameter may relate to a first stroke width. In these examples, the first operation may include presenting, according to the first stroke width, a representation of handwriting input or drawing input sensed by the device based on movement of the portion of the user's body above the display. The representation may be progressively presented as handwriting input or drawing input is received.

Also in some examples, the first user input parameter may relate to a first position of a slider along a volume level scale. In these examples, the first operation may include positioning the slider along the volume level scale at the first position and adjusting a volume level for the device to a first volume level corresponding to the first position. According to these examples, in some embodiments the instructions may even be further executable to identify a second height of a hover of the portion of the user's body over the display in a second instance occurring after the first instance, where the second height may be different from the first height. The instructions may then be executable to correlate the second height to a second user input parameter related to a second position of the slider along the volume level scale, where the second position may be different from the first position. The instructions may then be executable to execute a second operation at the device in conformance with the second user input parameter, where the second operation may include positioning the slider along the volume level scale at the second position and adjusting a volume level for the device to a second volume level corresponding to the second position. The second volume level may be different from the first volume level.

In other examples the first user input parameter may relate to a first position of a slider along a display brightness level scale. In these examples, the first operation may include positioning the slider along the display brightness level scale at the first position and adjusting a display brightness level for the device to a first display brightness level corresponding to the first position. According to these examples, in some embodiments the instructions may even be further executable to identify a second height of a hover of the portion of the user's body over the display in a second instance occurring after the first instance, where the second height may be different from the first height. The instructions may then be executable to correlate the second height to a second user input parameter related to a second position of the slider along the display brightness level scale, where the second position may be different from the first position. The instructions may then be executable to execute a second operation at the device in conformance with the second user input parameter, where the second operation may include positioning the slider along the display brightness level scale at the second position and adjusting a display brightness level for the device to a second display brightness level corresponding to the second position. The second display brightness level may be different from the first display brightness level.

Additionally, in some implementations the display may be a capacitive touch-enabled display and input from the capacitive touch-enabled display may be used to identify the first height. Additionally or alternatively, the device may include at least one proximity sensor other than the capacitive touch-enabled display, and the first height may be identified based on input from the at least one proximity sensor other than the capacitive touch-enabled display. The at least one proximity sensor may include, for example, a camera, an infrared proximity sensor, a radar transceiver, and/or a sonar transceiver.

Also, note that in some implementations the hover of the portion of the user's body over the display may not include the portion of the user's body physically touching the display.

Still further, in some embodiments the instructions may be executable to identify a first predefined gesture as being performed by the user and to, based on the identification of the first predefined gesture, set the device to use the first user input parameter in the future regardless of whether the height of the hover of the portion of the user's body changes. The device may be set to use the first user input parameter in the future at least until a second predefined gesture is identified by the device and/or at least until the first operation has been completed.

In another aspect, a method includes identifying, in a first instance, a first height of a hover of an object over an electronic display of a device. The method also includes controlling the device to perform at least one function based on the first height. The object may be a stylus and/or a portion of a user's body.

In some examples, the at least one function may include presenting, according to a first stroke width correlated to the first height, a representation of handwriting input or drawing input. The representation may be progressively presented as handwriting input or drawing input is received.

Also in some examples, the at least one function may include adjusting a volume level for the device to a first volume level determined based on the first height. Additionally or alternatively, the at least one function may include adjusting a display brightness level for the device to a first display brightness level determined based on the first height.

In still another aspect, at least one computer readable storage medium (CRSM) that is not a transitory signal may include instructions executable by at least one processor to identify a height of a hover of an object over an electronic display. The instructions may also be executable to correlate the height to a first user input parameter and to execute at least a first operation at a device in conformance with the first user input parameter.

In certain examples, the first user input parameter may pertain to a size of a display area for selection. In these examples, the instructions may be executable to identify a first area of the display that corresponds to the size of the display area for selection and that is at least partially disposed beneath the object. The instructions may then be executable to execute the first operation at least in part by facilitating a user selection of the first area.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIGS. 3 and 5 show top plan views according to an example for selecting a display area of a certain size using a finger hover, and FIGS. 4 and 6 show side elevational views according to this example;

FIGS. 7-9 show additional examples of use of a finger hover to control device operations consistent with present principles;

FIG. 10 is a flow chart of an example algorithm consistent with present principles; and

FIG. 11 shows an example graphical user interface (GUI) for configuring one or more settings of a device consistent with present principles.

### DETAILED DESCRIPTION

The present application describes use of a user's finger hovering over an electronic display to control operation of a device. For instance, after hover input functionality is invoked by bringing the finger close to the touch screen area (e.g., within a predefined distance), a given setting or function can be selected or changed by bringing the finger closer or farther from the display.

For example, if the user wants to select a relatively large area of the display then the finger may be positioned closer to the display. Conversely, if a smaller portion of the display is to be selected, then the finger can be pulled farther from the display. In this fashion, the size of the selection area can be dynamically controlled by simply moving the finger closer to/farther from the display.

As another example, if a user is using a paint application, if the finger is hovering closer to the display then a wider pen will be selected. As the finger is moved farther from the display, the size of the pen will get thinner and thinner. A graphical user interface presented on the display to the side of the application may even graphically show how large the brush/pen is at varying distances at which the finger might be positioned. Furthermore, once a desired size has been selected, a gesture of the finger such as a fast up/down movement may lock in the size, allowing the user move around the display using the selected size without the selected size changing even if hover height changes.

Prior to delving into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino Calif., Google Inc. of Mountain View, Calif., or Microsoft Corp. of Redmond, Wash. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any general purpose single- or multi-chip processor that can execute logic by means of various lines such as address lines, data lines, and control lines and registers and shift registers. Moreover, any logical blocks, modules, and circuits described herein can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, CD ROM or Flash drive). The software code instructions may also be downloaded over the Internet. Accordingly, it is to be understood that although a software application for undertaking present principles may be vended with a device such as the system 100 described below, such an application may also be downloaded from a server to a device over a network such as the Internet.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library.

Logic when implemented in software, can be written in an appropriate language such as but not limited to C # or C++, and can be stored on or transmitted through a computer-readable storage medium (that is not a transitory, propagating signal per se) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

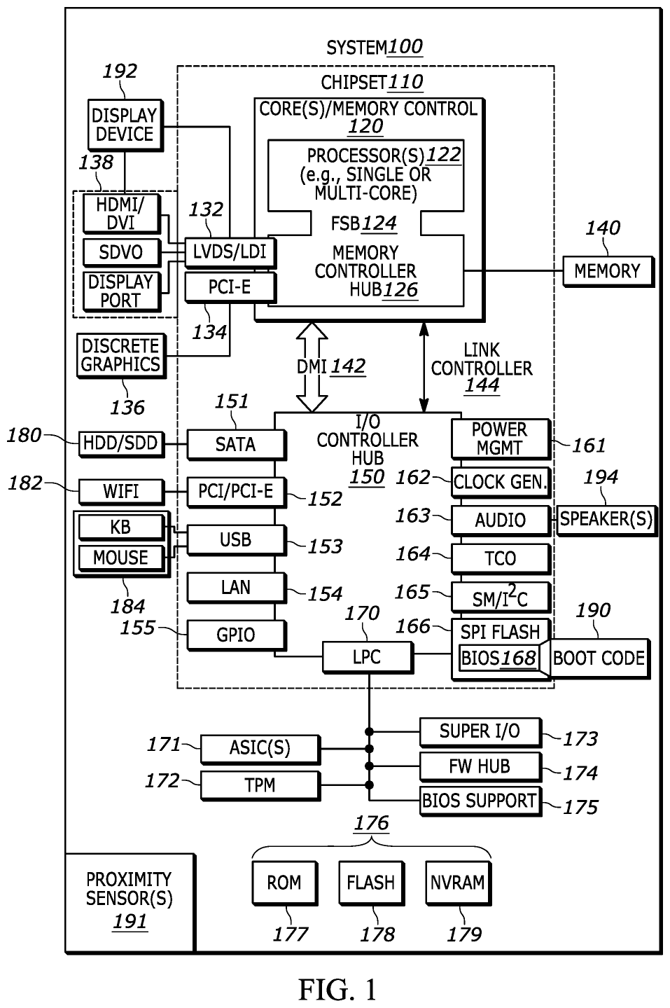

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192. The display device 192 may be e.g., a CRT, a flat panel, a projector, a touch-enabled light emitting diode display such as a capacitive or resistive touch-enabled LED display, another video display type, etc. A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (×16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

The system 100 may also include one or more proximity sensors 191 other than the touch-enabled display itself. The proximity sensor(s) 191 may include a camera, an infrared (IR) proximity sensor, a radar transceiver, and/or a sonar/ultrasound transceiver. The camera may be used to gather one or more images and provide the images to the processor 122. The camera may be a thermal imaging camera, an infrared (IR) camera, a digital camera such as a webcam, a three-dimensional (3D) camera, and/or a camera otherwise integrated into the system 100 and controllable by the processor 122 to gather pictures/images and/or video. In implementations where an IR proximity sensor may establish the at least one sensor 191, the IR proximity sensor may include one or more IR light-emitting diodes (LEDs) for emitting IR light as well as one or more photodiodes and/or IR-sensitive cameras for detecting reflections of IR light from the LEDs off of an object proximate to the device.

Additionally, though not shown for simplicity, in some embodiments the system 100 may include a gyroscope that senses and/or measures the orientation of the system 100 and provides input related thereto to the processor 122, as well as an accelerometer that senses acceleration and/or movement of the system 100 and provides input related thereto to the processor 122. Still further, the system 100 may include an audio receiver/microphone that provides input from the microphone to the processor 122 based on audio that is detected, such as via a user providing audible input to the microphone.

Also, the system 100 may include a GPS transceiver that is configured to communicate with at least one satellite to receive/identify geographic position information and provide the geographic position information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

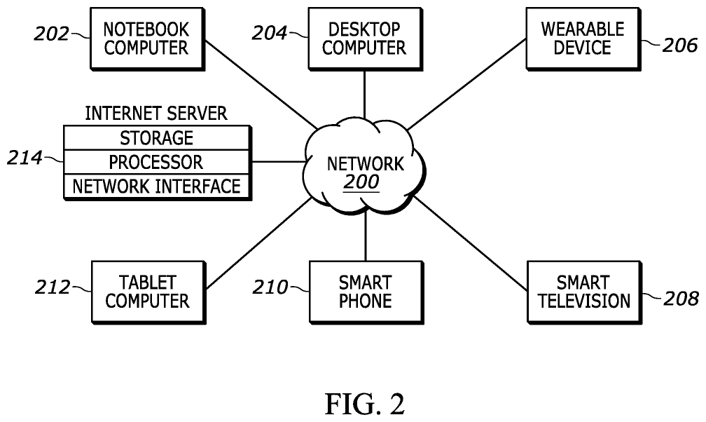

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 are configured to communicate with each other over the network 200 and to undertake present principles.

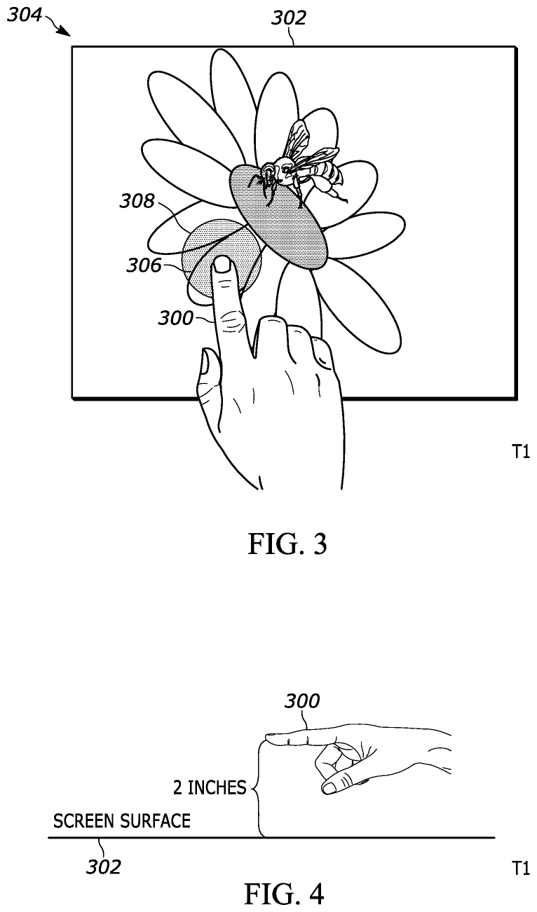

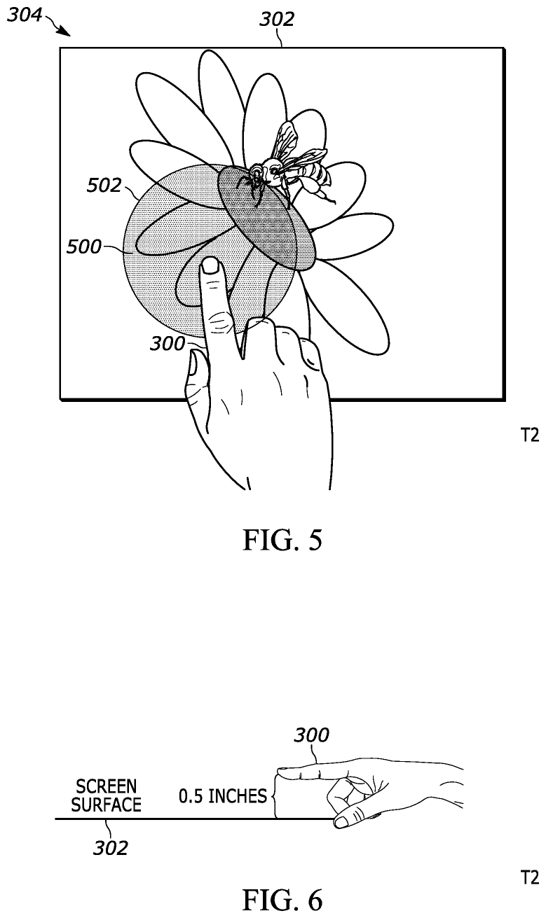

FIGS. 3-6 show one example for using the height at which a user hovers his or index finger 300 or a separate input device (such as a stylus) over a display 302 for providing input to a device 304. It is to be understood that FIGS. 3 and 5 show top plan views of the user interacting with the device 304 while the device 304 is resting face-up on a table, while FIGS. 4 and 6 show side elevational views of the user interacting with the device 304 while resting on the table. However, note consistent with present principles that the device 304 need not necessarily be resting on a table and that, for example, the device 304 may be held by the user in a hand opposite the hand with the index finger 300. Accordingly, it is to be understood that hover “height” as used herein may refer to the position of the user's finger (or input device) above the display 302 while hovering over but not physically touching the display 302 regardless of the orientation of the device 304 with respect to the ground/Earth.

As shown in FIGS. 3 and 5, the display 302 is presenting a particular photograph. FIGS. 3 and 4 illustrate that in a first instance at a first time, the user's index finger 300 has been positioned at a first height over the display 302, which in this example is two inches. This may be done by the user in order to define a size of an area of the display 304 for selection. The device may determine the size of the area for selection based on hover height by, for example, accessing a data table or relational database correlating respective hover heights to respective area sizes.

Thus, based on the device 304 sensing the hover height of two inches, the device 304 may highlight a first area 306 of the photograph with a circle 308 to indicate the size of the area that is being selected via the two-inch hover. The position of the area 306 may be centered beneath the end portion or tip of the user's finger 300 as sensed by the device 304. An operation may then be executed using the device 304 and the selected area 306, such darkening the area 306 during photo editing, extracting the area 306 to create a separate photograph showing the area 306 but not surrounding portions of the base photograph, selecting an application icon presented within the area 306, etc. The area 306 may also define a stroke width for electronic handwriting or drawing over top of the photograph using the finger 300, as another example of an operation that may be performed.

Now referring to FIGS. 5 and 6, as shown in these figures in a second instance at a second time later than the first time, the user's index finger 300 has been moved to a second height over the display 302, which in now half an inch. By the user lowering the height of the finger 300 over the display 302, the user has now provided input selecting a different-sized area 500 beneath the tip of the user's finger 300 that is greater than the area 306. The area 500 may be highlighted by the display 302 via the circle 502 that circumscribes the area 500, and an operation may then be executed using the device 304 and the selected area 500. It may thus be appreciated from FIGS. 3-6 that, in this example, the closer the user's hover is to the display 302, the greater the area is that is being selected.

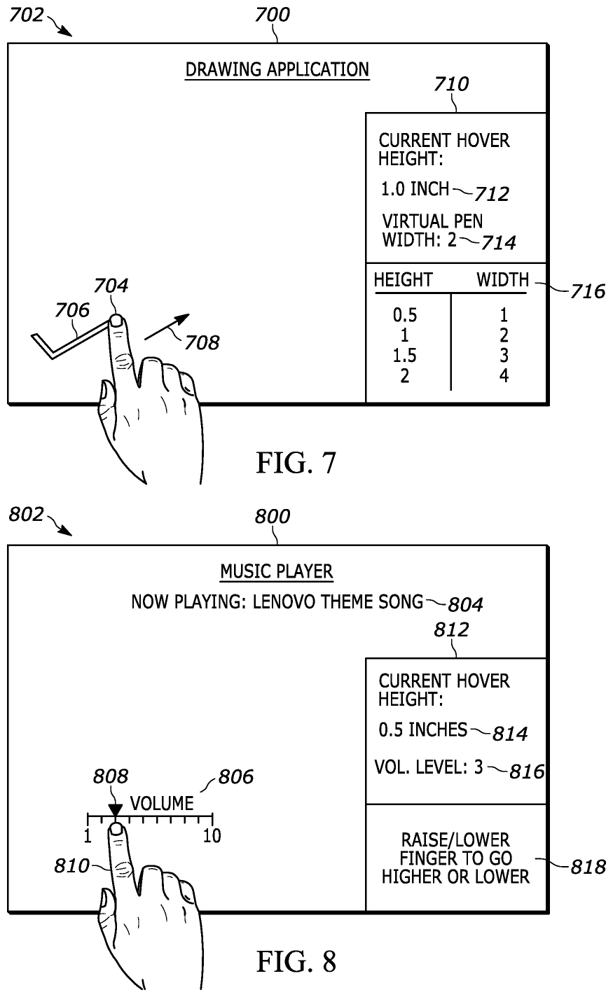

FIG. 7 shows another example consistent with present principles. In FIG. 7, a drawing application is being executed by a device to present a graphical user interface (GUI) 700 on a touch-enabled display 702. The GUI 700 may be used to provide handwriting input or input of a drawing using a user's index finger 704 (or stylus) while the finger 704 hovers over but does not physically touch the display 702. As illustrated, the user is drawing a check mark 706 on the GUI 700 as sensed via the touch-enabled display 702, with the check mark 706 having a particular stroke width(s) defined by the height of the hover of the user's index finger 704 above the display 702 at the time respective portions of the drawing input of the check mark were detected. Arrow 708 illustrates the motion being made by the user to progressively draw the check mark 706 over time.

FIG. 7 also shows that a subsection 710 of the GUI 700 may include an indication 712 of the current, real-time hover height of the finger 704 above the display. The subsection 710 may also include an indication 714 of the corresponding stroke width determined by the device based on the current hover height. The device may determine the stroke width based on hover height by, for example, accessing a data table or relational database correlating respective hover heights to respective stroke widths to use. Representations 716 of those correlations may be presented to the user via the subsection 710 so that a user may know at which height to hover the finger 704 in order to use a particular stroke width.

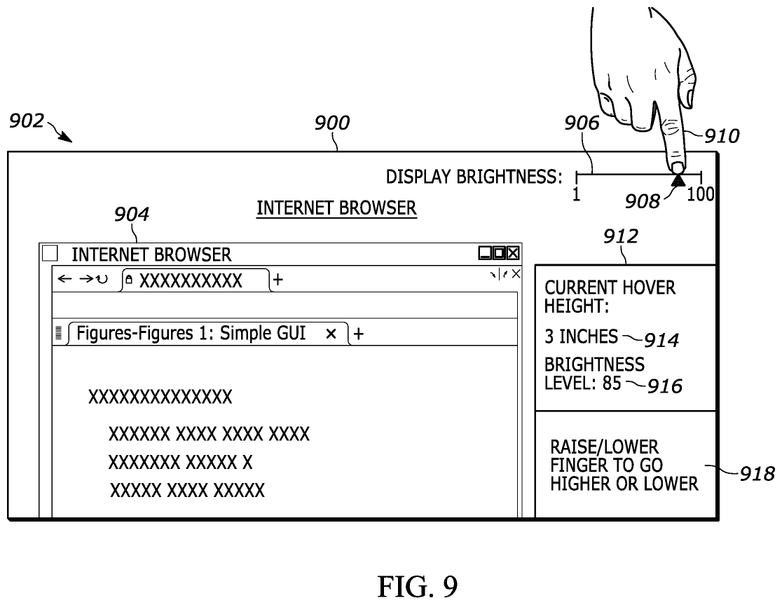

FIG. 8 shows yet another example consistent with present principles. In FIG. 8, a music player application is being executed by a device to audibly present music via the device as well as to present a GUI 800 on a touch-enabled electronic display 802. The GUI 800 may indicate information 804 such as the song currently being presented.

As also shown, the GUI 800 may include a volume level scale 806 showing volume levels from one to ten for speakers of the device to output sound at a specified volume level. To specify the volume level, a slider 808 may be moved or slid back and forth along the scale 806 by a user to a position corresponding to the desired volume level. Consistent with present principles, the user may do so by hovering his or her finger 810 over the scale 806 at a position to which the slider 808 is to be automatically moved and the device may then automatically move the slider 808 to the selected position and adjust the volume level for presenting the music accordingly.

A subsection 812 is also show on the GUI 800. The subsection 812 may include an indication 814 of the current, real-time hover height of the finger 810 above the display along with an indication 816 of the corresponding volume level determined by the device based on the current hover height. The device may determine the volume level based on hover height by, for example, accessing a data table or relational database correlating respective hover heights to respective volume levels to apply. Representations of those correlations may be presented via the GUI 800 similar to as set forth above for the representations 716 of FIG. 7, though not actually shown in FIG. 8 for simplicity.

The subsection 812 may also include instructions 818 indicating that the user may raise or lower his or her hovering finger to further adjust the volume level higher or lower, respectively. Thus, while continuously hovering the finger 810 over the scale 806 but changing the height of the hover, the user may progressively adjust or move the slider 808 back and forth along the scale 806 and thus progressively adjust the corresponding volume level.

FIG. 9 shows still another example consistent with present principles. In FIG. 9, an Internet browser application is being executed by a device to present a web page via a GUI 900 that is presented on a touch-enabled electronic display 902. The GUI 900 may indicate web page information 904 such as links to news articles, online encyclopedia information, emails, etc.

As also shown, the GUI 900 may include a display brightness level scale 906 showing display brightness levels from one to one hundred at which the display 902 may present content. To specify the display brightness level, a slider 908 may be moved or slid back and forth along the scale 906 by a user to a position corresponding to the desired display brightness level. Consistent with present principles, the user may do so by hovering his or her finger 910 over the scale 906 at a position to which the slider 908 is to be automatically moved and the device may then automatically move the slider 908 to the selected position and adjust the display brightness level for presenting content accordingly.

A subsection 912 is also shown on the GUI 900. The subsection 912 may include an indication 914 of the current, real-time hover height of the finger 910 above the display along with an indication 916 of the corresponding display brightness level determined by the device based on the current hover height. The device may determine the display brightness level based on hover height by, for example, accessing a data table or relational database correlating respective hover heights to respective display brightness levels to apply. Representations of those correlations may be presented via the GUI 900 similar to as set forth above for the representations 716 of FIG. 7, though not actually shown in FIG. 9 for simplicity.

The subsection 912 may also include instructions 918 indicating that the user may raise or lower his or her hovering finger to further adjust to display brightness level higher or lower, respectively. Thus, while continuously hovering the finger 910 over the scale 906 but changing the height of the hover, the user may progressively adjust or move the slider 908 back and forth along the scale 906 and thus progressively adjust the corresponding display brightness level for the light intensity at which content is to be presented on the display 902.

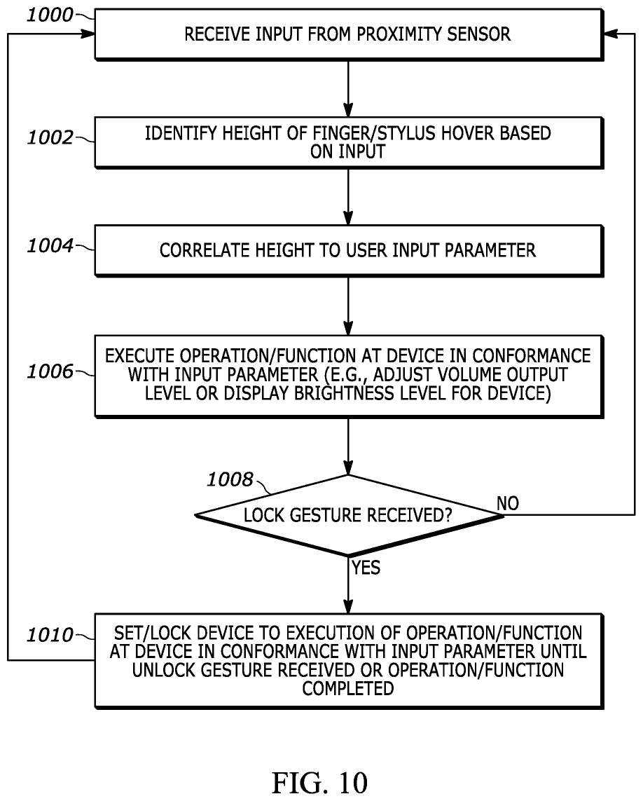

Referring now to FIG. 10, it shows example logic consistent with present principles that may be executed by a device such as the system 100 and/or any of the other devices disclosed herein. Beginning at block 1000, the device may receive input from at least one proximity sensor on or in communication with the device. The proximity sensor(s) may be established by the device's touch-enabled display itself, e.g., where that display is a capacitive touch-enabled display. Additionally or alternatively, the proximity sensor(s) may be established by a camera, an infrared (IR) proximity sensor, a radar transceiver, a sonar transceiver, etc.

From block 1000 the logic may then proceed to block 1002. At block 1002 the device may identify the current height of a user's body part hovering over the touch-enabled display. In examples where the proximity sensor is the touch-enabled display itself, both mutual capacitance and self-capacitance technologies may be used in combination to detect the hover height over the display based on the amount of the hover's disturbance of the touch-enabled display's electrical field at a particular location. However, in other implementations only one or the other capacitance technologies may be used. In any case, it is to be understood that in at least some examples the amount of disturbance at a particular location may be directly correlated to hover height.

In examples where the proximity sensor is a camera, to determine the height of the most-proximate portion of the user's finger to the touch-enabled display the device may use images generated by the camera as well as object recognition software, spatial analysis software, etc. to identify the height. Comparison of the location of the finger as shown in the images to known locations of objects that are also shown in the images may also be used to identify the height.

In examples where an IR proximity sensor is used, the IR proximity sensor may include one or more IR light-emitting diodes (LEDs) for emitting IR light as well as one or more photodiodes and/or IR-sensitive cameras for detecting reflections of IR light from the LEDs off of the user's body/finger back to the IR proximity sensor. The time of flight and/or detected intensity of the IR light reflections may then be used to determine the height of the most-proximate portion of the user's finger to the touch-enabled display. Note that radar transceivers and/or sonar/ultrasound transceivers and associated algorithms may also be used for determining hover height.

From block 1002 the logic may then proceed to block 1004. At block 1004 the device may correlate the identified hover height to a particular user input parameter, such as a particular volume level or display brightness level as disclosed above. The device may do so at block 1004 by, for example, accessing a relational database configured by the device's developer or an application developer, with the database correlating respective hover heights to respective particular user input parameters of one or more types.

From block 1004 the logic may then move to block 1006. At bock 1006 the device may execute an operation or function in conformance with the correlated user input parameter, such as changing a volume level or display brightness level as disclosed herein. Other example operations or functions include presenting representations of drawings or handwriting at particular stroked widths correlated to respective hover heights as well as selecting display areas of certain sizes correlated to respective hover heights.

From block 1006 the logic may then proceed to decision diamond 1008. At diamond 1008 the device may determine whether a predefined lock gesture has been identified/received. The lock gesture may be provided by the user to command the device to set or lock itself to use the particular user input parameter identified at block 1004 in the future regardless of whether the height of the hover of the portion of the user's body might change after that. So, for example, where the user reaches a desired stroke width to use for drawing by hovering his or her finger at a certain height, the user may subsequently begin a lock gesture motion from that height for the device to identify to then lock in the desired stroke width and use it to represent the user's drawing on the touch-enabled display regardless of whether the height of the user's hover might change after that point as the user draws.

As shown in FIG. 8, a negative determination at diamond 1008 may cause the logic to revert directly back to block 1000 so that the device can track any changes to the hover height and respond accordingly. However, an affirmative determination at diamond 1008 may instead cause the logic to proceed to block 1010 where the device may set itself according to the lock gesture. The device may thus lock in the identified user input parameter until another predefined unlock gesture is received (e.g., the same gesture as the lock gesture itself or a different gesture). Additionally or alternatively, the device may lock in the identified input parameter until the operation or function itself has been completed (e.g., the user stops drawing for a threshold amount of time, the user closes the application being used to draw, etc.).

The lock and unlock gestures themselves may both be, for example, air taps where the user's finger tip makes a quick up/down gesture with respect to the display while hovering over it. Or in examples where the unlock gesture is different from the lock gesture, the lock gesture may be the air tap and the unlock gesture may be an air swipe where the user's finger tip makes a quick back and forth gesture in a plane parallel to the display while hovering over it. The gestures themselves may be identified a number of ways, such as based on images from the camera on the device and execution of gesture recognition software. The gestures may also be identified based on input from the touch-enabled display itself, based on input from the IR proximity sensor, and/or based on input from the radar transceiver or sonar/ultrasound transceiver on the device.

Then after the unlock gesture is received or the operation or function has been completed, the logic may proceed from block 1010 back to block 1000 to proceed therefrom for the device to track any changes to the hover height and respond accordingly.

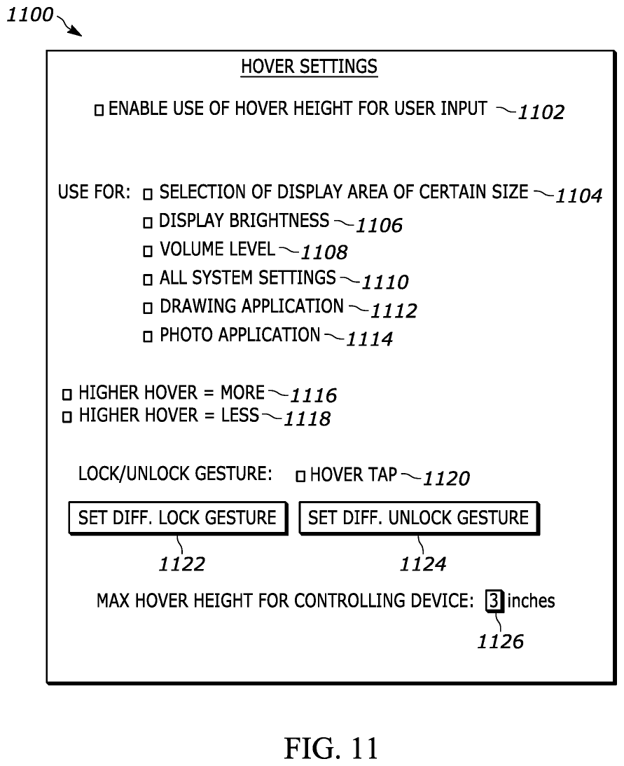

Continuing the detailed description in reference to FIG. 11, it shows an example settings GUI 1100 that may be presented on a display of a device. The GUI 1100 may be used to configure one or more settings of the device for operation consistent with present principles. The settings that will be described below may be selected by directing touch input or cursor input to the respective check boxes shown adjacent to each setting.

As shown, the GUI 1100 may include a first setting 1102 that is selectable to enable or set the device to use hover heights for determining user input parameters consistent with present principles. Thus, for example, the setting 1102 may be selected to configure the device to undertake the operations set forth above with respect to FIGS. 3-9 as well as to undertake the logic of FIG. 10.

The GUI 1100 may also include one or more settings 1104-1114 to configure the device to use hover heights to determine particular user input parameters only in certain contexts. For example, setting 1104 may be selected to configure the device to user hover heights for selection of display areas of certain sizes. Setting 1106 may be selected to configure the device to user hover heights for adjustment of display brightness levels, and setting 1108 may be selected to configure the device to user hover heights for adjustment of volume output levels. Setting 1110 may be selected to configure the device to use hover heights for all applicable system settings and operations that can be adjusted based on hover height. Setting 1112 may be selected to configure the device use hover heights for user inputs in relation to execution of a drawing application, and setting 1114 may be selected to configure the device to use hover heights for user inputs in relation to execution of a photograph editing application.

Still further, in some examples the GUI 1100 may include settings 1116 and 1118, where only one or the other may be selected at a given time. Thus, setting 1116 may be selected to set the device to correlate higher hovers (of greater distances) with greater respective user input parameters (e.g., higher volume levels or more luminous display brightness levels). Conversely, setting 1118 may be selected to set the device to correlate higher hovers with lesser respective user input parameters (e.g., lower volume levels or less luminous display brightness levels).

As also shown in FIG. 11, the GUI 1100 may include a setting 1120 to use air taps for lock and unlock gestures as described above. However, the user may also initiate a process to define his or her own lock gesture by selecting selector 1122 and to define his or her own unlock gesture by selecting 1124. The user may also set a maximum hover height that is to be used for controlling operations of the device consistent with present principles by directing numerical input to input box 1126. Thus, the device may control its operations and functions by detecting hovers above its display within the maximum hover height while ignoring hover heights for such purposes that are identified as more than the maximum distance.

Before concluding, also note that present principles may be applied to still other device operations. For example, hover input may be used to select an application's icon using a certain selection area size, to select a particular component or area of a schematic diagram, to increase the magnification level of a display presentation, or to increase the font size of presented text, etc.

It may now be appreciated that present principles provide for an improved computer-based user interface that improves the functionality and ease of use of the devices disclosed herein. The disclosed concepts are rooted in computer technology for computers to carry out their functions.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

What is claimed is:

1. A device, comprising:
at least one processor;
a display accessible to the at least one processor; and
storage accessible to the at least one processor and comprising instructions executable by the at least one processor to:
identify, in a first instance, a first height of a hover of a portion of a user's body over the display;
correlate the first height to a first user input parameter;
execute at least a first operation at the device in conformance with the first user input parameter.

2. The device of claim 1, wherein the first user input parameter relates to a first stroke width, and wherein the first operation comprises presenting, according to the first stroke width, a representation of handwriting input or drawing input sensed by the device based on movement of the portion of the user's body above the display, the representation being progressively presented as handwriting input or drawing input is received.

3. The device of claim 1, wherein the first user input parameter relates to a first position of a slider along a volume level scale, and wherein the first operation comprises positioning the slider along the volume level scale at the first position and adjusting a volume level for the device to a first volume level corresponding to the first position.

4. The device of claim 3, wherein the instructions are executable to:
identify, in a second instance occurring after the first instance, a second height of a hover of the portion of the user's body over the display, the second height being different from the first height;
correlate the second height to a second user input parameter related to a second position of the slider along the volume level scale, the second position being different from the first position; and
execute a second operation at the device in conformance with the second user input parameter, wherein the second operation comprises positioning the slider along the volume level scale at the second position and adjusting a volume level for the device to a second volume level corresponding to the second position, the second volume level being different from the first volume level.

5. The device of claim 1, wherein the first user input parameter relates to a first position of a slider along a display brightness level scale, and wherein the first operation comprises positioning the slider along the display brightness level scale at the first position and adjusting a display brightness level for the device to a first display brightness level corresponding to the first position.

6. The device of claim 5, wherein the instructions are executable to:
identify, in a second instance occurring after the first instance, a second height of a hover of the portion of the user's body over the display, the second height being different from the first height;
correlate the second height to a second user input parameter related to a second position of the slider along the display brightness level scale, the second position being different from the first position; and
execute a second operation at the device in conformance with the second user input parameter, wherein the second operation comprises positioning the slider along the display brightness level scale at the second position and adjusting a display brightness level for the device to a second display brightness level corresponding to the second position, the second display brightness level being different from the first display brightness level.

7. The device of claim 1, wherein the display is a capacitive touch-enabled display, and wherein input from the capacitive touch-enabled display is used to identify the first height.

8. The device of claim 1, comprising at least one proximity sensor accessible to the at least one processor, and wherein the first height is identified based on input from the at least one proximity sensor.

9. The device of claim 8, wherein the at least one proximity sensor comprises a camera, an infrared proximity sensor, a radar transceiver, a sonar transceiver.

10. The device of claim 1, wherein the hover of the portion of the user's body over the display does not comprise the portion of the user's body physically touching the display.

11. The device of claim 1, wherein the instructions are executable to:
identify a first predefined gesture as being performed by the user; and
based on the identification of the first predefined gesture, set the device to use the first user input parameter in the future regardless of whether the height of the hover of the portion of the user's body changes.

12. The device of claim 11, wherein the device is set to use the first user input parameter in the future at least until a second predefined gesture is identified by the device.

13. The device of claim 11, wherein the device is set to use the first user input parameter in the future at least until the first operation has been completed.

14. A method, comprising:
identifying, in a first instance, a first height of a hover of an object over an electronic display of a device; and
controlling the device to perform at least one function based on the first height.

15. The method of claim 14, wherein the object is selected from the group consisting of: a stylus, a portion of a user's body.

16. The method of claim 14, wherein the at least one function comprises presenting, according to a first stroke width correlated to the first height, a representation of handwriting input or drawing input, the representation being progressively presented as handwriting input or drawing input is received.

17. The method of claim 14, wherein the at least one function comprises adjusting a volume level for the device to a first volume level determined based on the first height.

18. The method of claim 14, wherein the at least one function comprises adjusting a display brightness level for the device to a first display brightness level determined based on the first height.

19. At least one computer readable storage medium (CRSM) that is not a transitory signal, the computer readable storage medium comprising instructions executable by at least one processor to:
identify a height of a hover of an object over an electronic display;
correlate the height to a first user input parameter; and
execute at least a first operation at a device in conformance with the first user input parameter.

20. The CRSM of claim 19, wherein the first user input parameter pertains to a size of a display area for selection, and wherein the instructions are executable to:
identify a first area of the display that corresponds to the size of the display area for selection and that is at least partially disposed beneath the object; and
execute the first operation at least in part by facilitating a user selection of the first area.
